(19) United States
(12) Patent Application Publication
(10) Pub. No.: US 2024/0286498 A1
(43) Pub. Date: Aug. 29, 2024

(54) Fuel Cell Module and Fuel Cell Apparatus Including the Same

(71) Applicants: Hyundai Motor COMPANY, Seoul (KR); Kia Corporation, Seoul (KR)

(72) Inventors: Hye Bin Park, Yongin-si (KR); Myung Jin Kim, Suwon-si (KR)

(21) Appl. No.: 18/344,238

(22) Filed: Jun. 29, 2023

(30) Foreign Application Priority Data
Feb. 27, 2023 (KR) 10-2023-0025897

(51) Int. Cl. B60L 50/71; B60L 3/00; B60L 50/72

(52) U.S. Cl. CPC B60L 50/71; B60L 3/0007; B60L 50/72

(57) ABSTRACT

An embodiment fuel cell module includes a fuel cell, a power distribution unit disposed above the fuel cell, the power distribution unit including a concave portion, and a cable configured to be connected to a connector of the power distribution unit within the concave portion. The power distribution unit according to an embodiment includes a front surface, a rear surface located opposite the front surface in a first direction, and first and second side surfaces facing each other in a vehicle width direction between the front surface and the rear surface, the vehicle width direction being a direction intersecting the first direction. In an embodiment, the connector is disposed on the first side surface or the second side surface to be connected to the cable.

### CROSS-REFERENCE TO RELATED APPLICATIONS

This application claims the benefit of Korean Patent Application No. 10-2023-0025897, filed on Feb. 27, 2023, which application is hereby incorporated herein by reference.

### TECHNICAL FIELD

Embodiments relate to a fuel cell module and a fuel cell apparatus including the same.

### BACKGROUND

In a fuel cell vehicle, which is a type of fuel cell apparatus, a power distribution unit serves to receive power generated in a fuel cell through a terminal block and to distribute the power to nearby high-voltage parts.

Basically, during a vehicle collision test, the risk of fire is high due to high-voltage parts. Therefore, it is necessary to establish a preventive measure to avoid damage to high-voltage parts through collision analysis/evaluation. In particular, when high-voltage parts (e.g., a high-voltage connector and a high-voltage cable connected to the connector) are disposed behind a power distribution unit, the high-voltage parts may be sandwiched between the power distribution unit and a dash panel of a vehicle and thus damaged in the event of a collision of the vehicle. If the high-voltage parts located behind the power distribution unit are damaged due to a collision of the vehicle, electric current may flow through the vehicle body, which may cause heat or fire. Therefore, research with the goal of protecting occupants in a vehicle and securing safety of high-voltage parts against a collision is underway.

Japanese Patent Unexamined Publication No. 2004-181979 and Japanese Patent Unexamined Publication No. 2021-049943 may provide information relevant to the technology of embodiments of the present invention.

### SUMMARY

Accordingly, embodiments are directed to a fuel cell module and a fuel cell apparatus including the same that substantially obviate one or more problems due to limitations and disadvantages of the related art.

Embodiments provide a fuel cell module, in which connectors and cables are safely disposed, and a fuel cell apparatus including the same.

However, features obtainable by the embodiments are not limited to the above-mentioned features, and other features not mentioned herein will be clearly understood by those skilled in the art from the following description.

A fuel cell module according to an embodiment may include a fuel cell, a power distribution unit disposed above the fuel cell and including a concave portion, and a cable configured to be connected to a connector of the power distribution unit within the concave portion.

In an example, the power distribution unit may include a front surface, a rear surface located opposite the front surface in a first direction, and first and second side surfaces facing each other in a vehicle width direction between the front surface and the rear surface, the vehicle width direction being a direction intersecting the first direction. The connector may be disposed on at least one of the first or second side surface except for the rear surface to be connected to the cable.

In an example, the concave portion may be disposed closer to the rear surface of the power distribution unit than the front surface of the power distribution unit.

In an example, the concave portion may be spaced apart from the front surface of the power distribution unit and may be contiguous with the rear surface of the power distribution unit. The connector and the cable may be connected to each other within the concave portion while being spaced apart from a virtual rear surface, and the virtual rear surface may be a virtual surface extending from the rear surface in the vehicle width direction.

In an example, the concave portion may be located at a corner between at least one of the first or second side surface of the power distribution unit and the rear surface of the power distribution unit.

In an example, the concave portion may have a cut-out, chamfered, or filleted planar shape.

In an example, the connector may include a plurality of connectors configured to respectively output multiple different levels of voltages, and the cable may include a plurality of cables configured to be respectively connected to the plurality of connectors.

In an example, a highest level of voltage may be output through a target connector among the plurality of connectors. The plurality of cables may include a target cable configured to be connected to the target connector, and the target connector and the target cable may be connected to each other within the concave portion.

In an example, the target connector may include an FCMAIN connector configured to output a voltage required by a load of a vehicle equipped with the fuel cell module.

In an example, the plurality of connectors may include a longest connector having the longest length in the vehicle width direction, the plurality of cables may include a longest cable configured to be connected to the longest connector, and the longest connector and the longest cable may be connected to each other within the concave portion.

In an example, the fuel cell module may further include a fuel cell driving unit configured to assist driving of the fuel cell and a vehicle driving unit configured to assist driving of a vehicle equipped with the fuel cell module, and the fuel cell module may include a first module including the fuel cell, the fuel cell driving unit, and the vehicle driving unit, and a second module including the power distribution unit and the connector.

In an example, the second module may completely overlap the first module in a vertical direction.

In an example, the outermost side of the first module may be located farther away from the first or second side surface of the power distribution unit in the vehicle width direction than the outermost side of the connector.

In an example, a separation distance between the outermost side of the first module and the first or second side surface of the power distribution unit in the vehicle width direction may be longer than or equal to a separation distance between the outermost side of the connector and the first or second side surface of the power distribution unit in the vehicle width direction.

In an example, a separation distance between the outermost side of the first module and the outermost side of the cable in the first direction may be longer than or equal to a separation distance between the outermost side of the cable and the front surface of the power distribution unit in the first direction.

In an example, in the first direction, the outermost side of the first module may be located closer to the outermost surface of the vehicle than the outermost side of the cable.

In an example, the vehicle may include a vehicle body including an engine compartment in which the fuel cell module is removably received in the vertical direction.

In an example, the cable may include a first cable portion overlapping the power distribution unit in the vehicle width direction and a second cable portion extending from the first cable portion and overlapping the first module in the vehicle width direction.

In an example, the fuel cell module may further include a fixing part configured to fix the second cable portion to the first module.

In an example, the fuel cell module may further include an impact absorbing part configured to envelop the cable.

In an example, each of the plurality of cables may include a positive cable connected to a positive voltage output through a corresponding connector and a negative cable connected to a negative voltage output through the corresponding connector.

In an example, the positive cable and the negative cable included in at least one of the plurality of cables may be provided separately from each other in a mutually diverging manner.

In an example, the positive cable and the negative cable may have different lengths.

A fuel cell apparatus according to another embodiment may include the above fuel cell module.

### BRIEF DESCRIPTION OF THE DRAWINGS

The accompanying drawings, which are included to provide a further understanding of embodiments of the disclosure and are incorporated in and constitute a part of this application, illustrate exemplary embodiments of the disclosure and together with the description serve to explain the principle of embodiments of the disclosure. In the drawings:

FIGS. 1A and 1B are, respectively, a partially exploded perspective view and a coupled perspective view of a fuel cell vehicle according to an embodiment;

FIG. 2 is a partial plan view of the fuel cell vehicle according to an embodiment;

FIG. 3 is a rear view of a fuel cell module according to an embodiment;

FIG. 4 is a rear perspective view of the fuel cell module according to an embodiment;

FIGS. 5A to 5E are plan views showing various embodiments of the concave portion shown in FIG. 2;

FIG. 6 is a side view of a fuel cell vehicle according to a comparative example;

FIG. 7A is a plan view showing the state of the fuel cell vehicle according to the comparative example in the event of a head-on collision; and

FIG. 7B is a plan view showing the state of the fuel cell vehicle according to the comparative example in the event of an offset collision.

### DETAILED DESCRIPTION OF ILLUSTRATIVE EMBODIMENTS

Embodiments of the present disclosure will now be described more fully hereinafter with reference to the accompanying drawings, in which various embodiments are shown. The examples, however, may be embodied in many different forms, and should not be construed as being limited to the embodiments set forth herein. Rather, these embodiments are provided so that this disclosure will be more thorough and complete and will more fully convey the scope of the disclosure to those skilled in the art.

It will be understood that when an element is referred to as being “on” or “under” another element, it may be directly on/under the element, or one or more intervening elements may also be present.

When an element is referred to as being “on” or “under,” “under the element” as well as “on the element” may be included based on the element.

In addition, relational terms, such as “first”, “second”, “on/upper part/above”, and “under/lower part/below”, are used only to distinguish between one subject or element and another subject or element, without necessarily requiring or involving any physical or logical relationship or sequence between the subjects or elements.

Hereinafter, a fuel cell module and a fuel cell apparatus including the same according to embodiments will be described with reference to the accompanying drawings. The fuel cell apparatus according to an embodiment may be a vehicle, aircraft, ship, stationary power generation system, or the like, but the embodiments are not limited thereto.

Hereinafter, the following description will be given on the assumption that the fuel cell apparatus according to an embodiment is a fuel cell vehicle. However, the following description may also be applied to a case in which the fuel cell apparatus is an apparatus other than a vehicle.

A fuel cell vehicle 100 will be described using the Cartesian coordinate system (x-axis, y-axis, z-axis) for convenience of description, but may also be described using other coordinate systems. In the Cartesian coordinate system, the x-axis, the y-axis, and the z-axis are perpendicular to each other, but the embodiments are not limited thereto. That is, the x-axis, the y-axis, and the z-axis may intersect each other obliquely. Hereinafter, for convenience of description, the x-axis direction will be referred to as a “first direction” or a “heading direction,” the y-axis direction will be referred to as a “second direction” or a “vehicle width direction,” and the z-axis direction will be referred to as a “third direction” or a “vertical direction.”

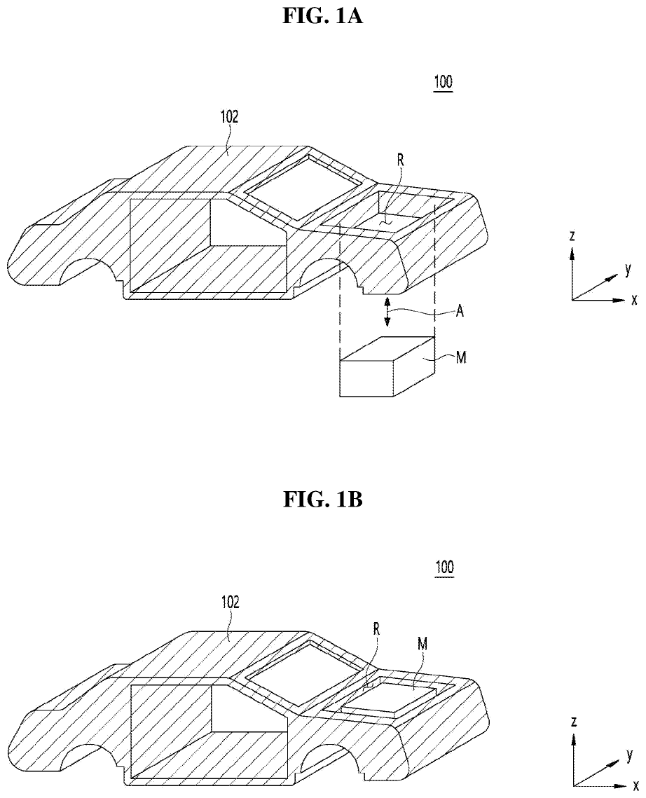

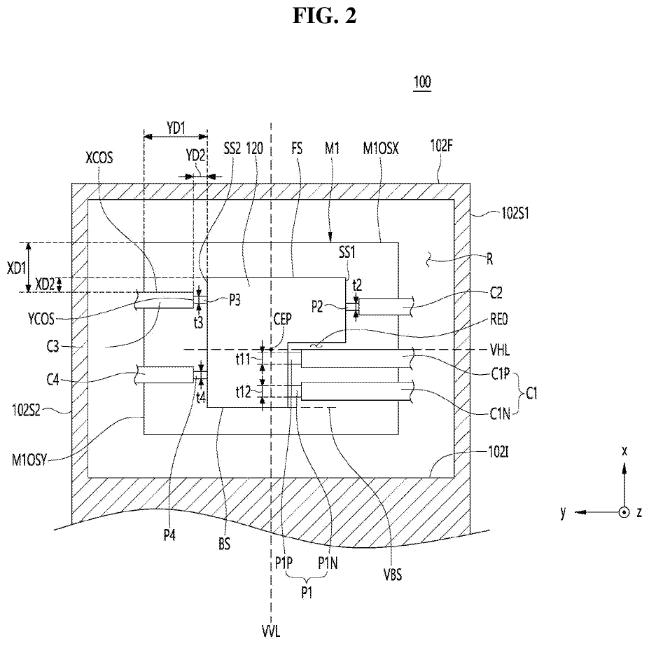

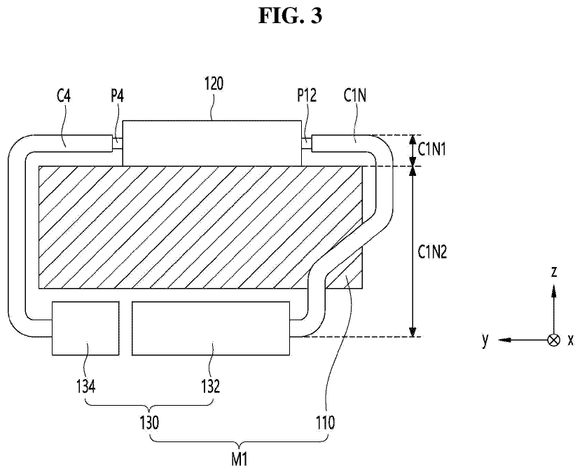

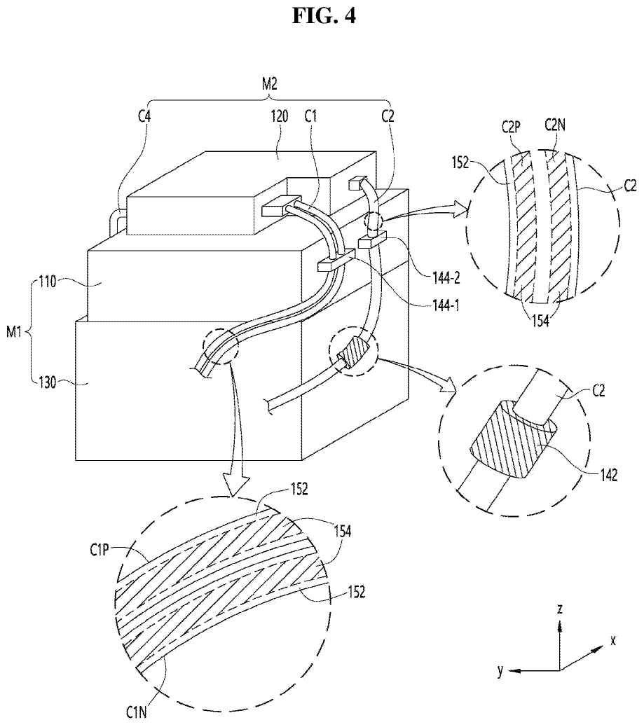

FIGS. 1A and 1B are, respectively, a partially exploded perspective view and a coupled perspective view of the fuel cell vehicle 100 according to an embodiment, FIG. 2 is a partial plan view of the fuel cell vehicle 100 according to an embodiment, FIG. 3 is a rear view of a fuel cell module according to an embodiment included in the fuel cell vehicle 100 according to an embodiment, and FIG. 4 is a rear perspective view of the fuel cell module according to an embodiment.

According to an embodiment, the fuel cell vehicle 100 may include a fuel cell module.

The fuel cell module may include a fuel cell 110, a power distribution unit (PDU) (a high-voltage junction box or a junction box) 120, and cables C (C1 to C4). Alternatively, the cables C may be components of the fuel cell vehicle, rather than components of the fuel cell module.

The fuel cell 110 serves to generate power. The fuel cell 110 may be, for example, a polymer electrolyte membrane fuel cell (or a proton exchange membrane fuel cell) (PEMFC), which has been studied most extensively as a power source for driving fuel cell vehicles, which are fuel cell apparatuses. However, the embodiments are not limited to any specific form of the fuel cell 110.

The fuel cell 110 may include a cell stack (not shown) and a current collector (or a current collecting terminal) (not shown).

The cell stack may include a plurality of unit cells that are stacked one above another in the first direction, which is the heading direction (or the travel direction) of the fuel cell vehicle 100, or the second direction, which intersects the first direction.

The power distribution unit 120 is disposed above the fuel cell 110 and serves to receive power generated in the fuel cell 110 through a terminal block (not shown) and to distribute the power to nearby parts that need power in the fuel cell vehicle 100. To this end, a heater and the current collector in the fuel cell 110 may be connected to the power distribution unit 120. For example, the power distribution unit 120 may be a part that is located at the highest position among the parts disposed in an engine compartment R of the fuel cell vehicle 100.

The power distribution unit 120 may serve to distribute the power received through the terminal block to nearby parts for operating the fuel cell vehicle 100, i.e., loads, through the cables C. To this end, the power distribution unit 120 may include a housing (not shown) and switches (not shown) or relays (not shown), which are mounted in the housing.

The power distribution unit 120 may include a front surface FS, a rear surface BS, a first side surface (or a right surface) SS1, and a second side surface (or a left surface) SS2.

The rear surface BS may be located opposite the front surface FS in the first direction. Here, the first direction may be a direction parallel to the travel direction of the fuel cell vehicle 100.

The first and second side surfaces SS1 and SS2 may face each other in the second direction, which is the vehicle width direction intersecting the first direction, between the front surface FS and the rear surface BS.

In addition, the power distribution unit 120 may include at least one connector P. The at least one connector P may include a plurality of connectors configured to respectively output multiple different levels of voltages.

Although the power distribution unit 120 is shown in FIG. 2 as including four connectors, the power distribution unit 120 may include more than four connectors. The four connectors P1 to P4 may be high-voltage connectors configured to output relatively high levels of voltages among the connectors included in the fuel cell module. For example, each of the four connectors P1 to P4 may output a high voltage ranging from 250 V to 450 V.

For example, the plurality of connectors P may include a fuel cell main (FCMAIN) connector P1, an IDC connector P2, a CSP/ACON connector P3, and an FACM connector P4.

Each of the connectors P shown in FIG. 2 is merely an example, and the embodiments are not limited to any specific form of each of the connectors P.

The function of each of the connectors P will be described below in brief.

The FCMAIN connector P1 may output a voltage required by a motor and/or an inverter (hereinafter referred to as a “motor/inverter”) 132, which is a load. The FCMAIN connector P1 may include a positive connector P1P and a negative connector PIN. The IDC connector P2 may output a voltage required by an integrated DC/DC converter (IDC) (not shown). The CSP connector P3 may output a voltage required by a coolant stack pump (CSP). The ACON connector P3 may output a voltage required by an air-conditioner compressor (ACON) (or a refrigerant compressor). The FACM connector P4 may output a voltage required by a fuel cell air compressor module (FACM). The CSP connector P3 and the ACON connector P3 may share one connector P3, as shown in FIG. 2, or may be provided separately from each other, unlike what is shown in FIG. 2.

Hereinafter, a connector outputting the highest level of voltage among the plurality of connectors included in the power distribution unit 120 will be referred to as a “target connector.” For example, the target connector may include the FCMAIN connector P1. The target connector may have the largest size among the plurality of connectors. That is, among the plurality of connectors, the target connector may have the largest size in each of the x-axis direction, which is the travel direction, the y-axis direction, which is the vehicle width direction, and the z-axis direction, which is the vertical direction.

For example, referring to FIG. 2, the sizes t11 and t12 of the positive connector P1P and the negative connector PIN of the FCMAIN connector P1, which is the target connector, in the first direction may be larger than each of the size t2 of the IDC connector P2 in the first direction, the size t3 of the CSP/ACON connector P3 in the first direction, and the size t4 of the FACM connector P4 in the first direction.

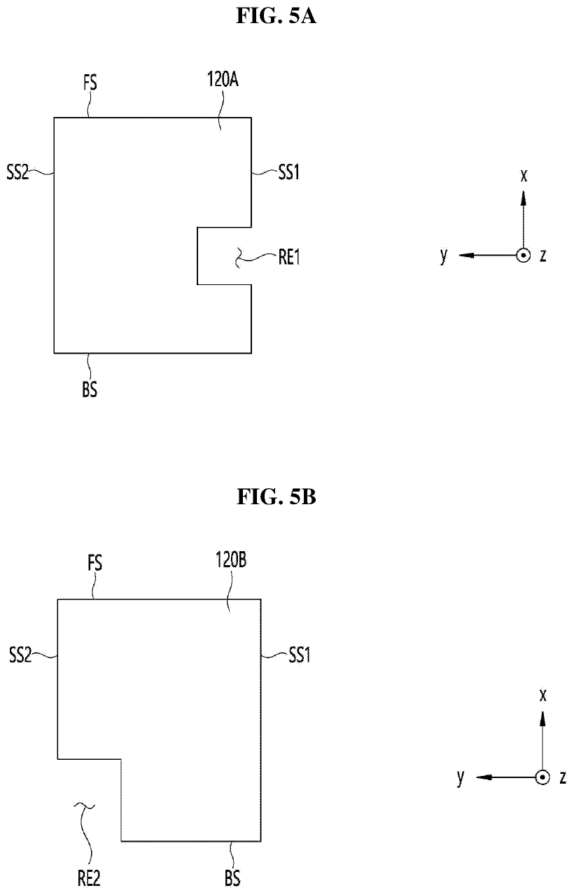

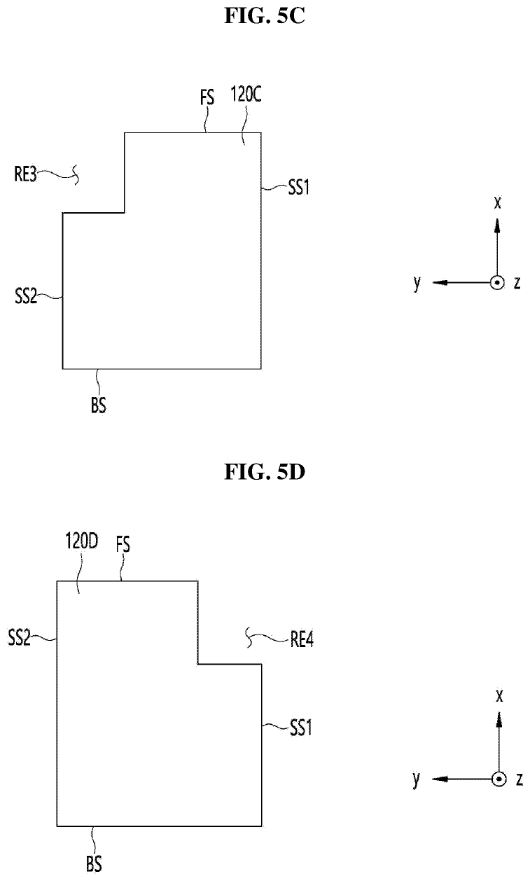

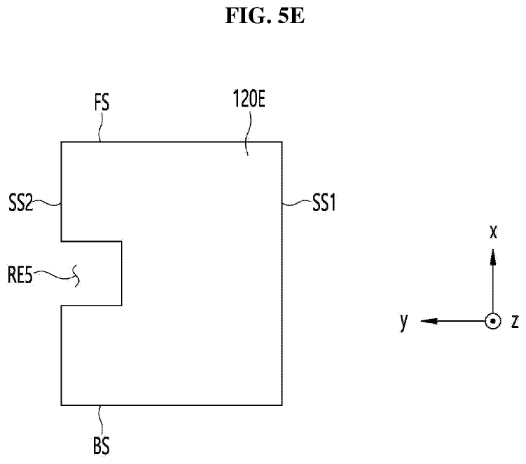

FIGS. 5A to 5E are plan views showing various embodiments of the concave portion shown in FIG. 2.

The power distribution unit 120 may include a concave portion (a recess or a cut-out portion). The concave portion may have a shape that is recessed when viewed in a plan view. To this end, the housing of the power distribution unit 120 may include a concave portion. For example, as illustrated in FIGS. 2 and 5B, the concave portion RE0 or RE2 may be disposed closer to the rear surface BS of the power distribution unit 120 or 120B than to the front surface FS thereof. In this case, the concave portion RE0 or RE2 may be spaced apart from the front surface FS of the power distribution unit 120 or 120B and may be contiguous with the rear surface BS of the power distribution unit 120 or 120B. Although the concave portion RE0 or RE2 is contiguous with the rear surface BS, the connector P1 and the cable C1 may be connected to each other within the concave portion RE0 or RE2 in the state of being spaced apart from a virtual rear surface VBS. The virtual rear surface VBS may be a virtual surface extending from the rear surface BS in the y-axis direction, which is the vehicle width direction.

Further, the concave portion may be located at a corner between at least one of the first or second side surface SS1 or SS2 of the power distribution unit 120 and the rear surface BS thereof. For example, as shown in FIG. 2, the concave portion RE0 may be located at a corner between the first side surface SS1 of the power distribution unit 120 and the rear surface BS thereof. Alternatively, as shown in FIG. 5B, the concave portion RE2 may be disposed at a corner between the second side surface SS2 of the power distribution unit 120B and the rear surface BS thereof.

Alternatively, the concave portion may be spaced apart from the front surface FS and the rear surface BS of the power distribution unit 120 and may be disposed in at least one of the first or second side surface SS1 or SS2 thereof. For example, as shown in FIG. 5A, the concave portion RE1 may be spaced apart from the front surface FS and the rear surface BS of the power distribution unit 120A and may be disposed in the first side surface SS1 thereof. Alternatively, as shown in FIG. 5E, the concave portion RE5 may be spaced apart from the front surface FS and the rear surface BS of the power distribution unit 120E and may be disposed in the second side surface SS2 thereof.

Alternatively, the concave portion may be located at a corner between at least one of the first or second side surface SS1 or SS2 of the power distribution unit 120 and the front surface FS thereof. For example, as shown in FIG. 5C, the concave portion RE3 may be located at a corner between the second side surface SS2 of the power distribution unit 120C and the front surface FS thereof. Alternatively, as shown in FIG. 5D, the concave portion RE4 may be disposed at a corner between the first side surface SS1 of the power distribution unit 120D and the front surface FS thereof.

According to embodiments, the concave portion may have various shapes. The concave portion may have a cut-out, chamfered, or filleted planar shape. For example, as shown in FIG. 2, 5B, 5C, or 5D, the concave portion RE0, RE2, RE3, or RE4 may have a chamfered planar shape.

Meanwhile, the cables C (C1 to C4) are respectively connected to the connectors P of the power distribution unit 120. The cables C and the connectors P may be connected to each other in a male/female form, but the embodiments are not limited to any specific connection form between the cables C and the connectors P.

Since the cables C are connected to the connectors P, the number of cables C may be identical to the number of connectors P, but may not be limited to the number of connectors P.

According to an embodiment, the connectors P and the cables C may be disposed on at least one of the first or second side surface SS1 or SS2 of the power distribution unit 120 except for the rear surface BS of the power distribution unit 120. For example, as shown in the drawings, the connectors P and the cables C may be disposed only on the first and second side surfaces SS1 and SS2 of the power distribution unit 120 and may not be disposed on the rear surface BS or the front surface FS of the power distribution unit 120.

While one side of the cable C is connected to the connector P on the side surface of the fuel cell module, i.e., at least one of the first or second side surface SS1 or SS2, the opposite side of the cable C may be connected to a fuel cell driving unit and a vehicle driving unit, which will be described later, on the side surface, the rear surface, or any other surface of the fuel cell module.

Meanwhile, a single cable C may be provided. Alternatively, the cable C may include a plurality of cables that are respectively connected to the plurality of connectors P. For example, the plurality of cables may include first to fourth cables C1 to C4, which are respectively connected to the FCMAIN connector P1, the IDC connector P2, the CSP/ACON connector P3, and the FACM connector P4.

At least some of the plurality of cables may be connected to the connectors of the power distribution unit 120 within the concave portion.

For example, the plurality of cables may include a cable that is connected to the aforementioned target connector (hereinafter referred to as a “target cable”). The target cable may have the largest thickness among the plurality of cables. The reason for this is that the target connector, which is connected to the target cable, outputs the highest level of voltage. For example, as shown in FIG. 2, the size of each of a positive cable C1P and a negative cable C1N of the first cable C1, which is the target cable, in the first direction may be larger than the size of each of the second to fourth cables C2, C3, and C4 in the first direction.

That is, the aforementioned FCMAIN connector P1 may correspond to the target connector, and the first cable C1 may correspond to the target cable. The target connector and the target cable may be connected to each other within the concave portion RE0, RE1, RE2, RE3, RE4, or RE5.

In addition, the fuel cell module according to an embodiment may further include a fuel cell driving unit and a vehicle driving unit. The fuel cell driving unit may serve to assist driving of the fuel cell 110, and may include, for example, a CSP and an FACM 134. The vehicle driving unit may serve to assist driving of the fuel cell vehicle 100, and may include, for example, a motor/inverter 132 and an ACON.

In the fuel cell vehicle 100 according to an embodiment, various parts may be modularized. That is, the fuel cell module M according to an embodiment may include a first module M1 and a second module M2.

The first module M1 may include the fuel cell 110, the fuel cell driving unit, and the vehicle driving unit, and the second module M2 may include the power distribution unit 120 and the connectors P.

Referring to FIG. 2, the entirety of the second module M2, i.e., the power distribution unit 120 and the connectors P, may be disposed inside the first module M1 when viewed in a plan view. That is, the entirety of the second module M2, i.e., the power distribution unit 120 and the connectors P, may overlap the first module M1 in the third direction, which is the vertical direction.

Hereinafter, among the connectors P, a connector protruding most in the vehicle width direction based on a first virtual reference line VVL or the first or second side surface SS1 or SS2 of the power distribution unit 120 will be referred to as a “transverse connector.” The outermost side of the first module M1 may be located farther away from the first virtual reference line VVL or the first or second side surface SS1 or SS2 of the power distribution unit 120 in the vehicle width direction than the outermost side of the transverse connector. Here, the first virtual reference line VVL may be a line that passes through the center CEP of the power distribution unit 120 and is parallel to the x-axis direction, which is the first direction.

First, the outermost side of the first module M1 may be located farther away from the second side surface SS2 of the power distribution unit 120 in the vehicle width direction than the outermost side of the transverse connector among the CSP/ACON connector P3 and the FAMAIN connector P4.

Similarly, the outermost side of the first module M1 may be located farther away from the first side surface SS1 of the power distribution unit 120 in the vehicle width direction than the outermost side of the transverse connector among the FCMAIN connector P1 and the IDC connector P2.

That is, the separation distance between the outermost side of the first module M1 and the first or second side surface SS1 or SS2 of the power distribution unit 120 in the second direction, which is the vehicle width direction, may be longer than or equal to the separation distance between the outermost side of the transverse connector and the first or second side surface SS1 or SS2 of the power distribution unit 120 in the vehicle width direction.

When the CSP/ACON connector P3 is the transverse connector among the CSP/ACON connector P3 and the FACM connector P4 that are connected to the second side surface SS2 of the power distribution unit 120, the separation distance YD1 between the outermost side M1OSY of the first module M1 and the second side surface SS2 of the power distribution unit 120 in the vehicle width direction (i.e., the y-axis direction) may be longer than or equal to the separation distance YD2 between the outermost side YCOS of the CSP/ACON connector P3 and the second side surface SS2 of the power distribution unit 120 in the vehicle width direction.

Similarly, when the IDC connector P2 is the transverse connector among the FCMAIN connector P1 and the IDC connector P2 that are connected to the first side surface SS1 of the power distribution unit 120, the separation distance between the outermost side of the first module M1 and the first side surface SS1 of the power distribution unit 120 in the vehicle width direction (i.e., the y-axis direction) may be longer than or equal to the separation distance between the outermost side of the IDC connector P2 and the first side surface SS1 of the power distribution unit 120 in the vehicle width direction.

In addition, hereinafter, among the cables C, a cable protruding most in the first direction (i.e., the x-axis direction) based on a second virtual reference line VHL will be referred to as a “longitudinal cable.” The separation distance between the outermost side of the longitudinal cable and the outermost side of the first module M1 in the first direction may be longer than or equal to the separation distance between the outermost side of the longitudinal cable and the front surface FS of the power distribution unit 120 in the first direction. Here, the second virtual reference line VHL may be a line that passes through the center CEP of the power distribution unit 120 and is parallel to the y-axis direction, which is the second direction.

When, among the first to fourth cables C1 to C4, the third cable C3 is the longitudinal cable protruding more in the first direction than the second cable C2, the separation distance XD1 between the outermost side M1OSX of the first module M1 and the outermost side XCOS of the third cable C3 in the first direction may be longer than or equal to the separation distance XD2 between the outermost side XCOS of the third cable C3 and the front surface FS of the power distribution unit 120 in the first direction.

Accordingly, the outermost side of the first module M1 may be located closer to the outermost surfaces 102S1, 102S2, and 102F of the fuel cell vehicle 100 than the outermost side of the transverse connector or the longitudinal cable. For example, in the first direction, the outermost side M1OSX of the first module M1 may be located closer to the outermost surface 102F of the fuel cell vehicle 100 than the outermost side XCOS of the longitudinal cable (e.g., C3). In addition, in the second direction, the outermost side M1OSY of the first module M1 may be located closer to the outermost surface 102S2 of the fuel cell vehicle 100 than the outermost side YCOS of the transverse connector (e.g., P3).

In addition, the outermost side of the first module M1 may be located closer to the outermost surface 102F of the fuel cell vehicle 100 than the outermost side of the connector protruding most in the first direction.

The fuel cell vehicle 100 according to an embodiment may further include a vehicle body 102 including an engine compartment R in which the fuel cell module M is removably received in the vertical direction, i.e., the direction indicated by the arrow A in FIG. 1A.

Meanwhile, a voltage output from each of the connectors P (P1, P2, P3, and P4) of the power distribution unit 120 corresponds to an electric potential difference between a first point and a second point. In this case, the electric potential of the second point may be higher than the electric potential of the first point, the first point may have a negative electric potential (hereinafter referred to as a “negative voltage”), and the second point may have a positive electric potential (hereinafter referred to as a “positive voltage”).

Each of the aforementioned cables C (C1 to C4) may include a positive cable and a negative cable.

The positive cable may be connected to a positive voltage output through a corresponding connector, and the negative cable may be connected to a negative voltage output through a corresponding connector.

The positive cable and the negative cable included in at least one of the plurality of cables may be provided separately from each other in a mutually diverging manner. In this case, the positive cable and the negative cable may have different lengths. For example, referring to FIG. 4, the first cable C1 includes a positive cable C1P and a negative cable C1N, and the second cable C2 includes a positive cable C2P and a negative cable C2N. The positive cable C1P of the first cable C1 may be connected to the positive connector P1P of the FCMAIN connector P1, and the negative cable C1N of the first cable C1 may be connected to the negative connector PIN of the FCMAIN connector P1.

According to an embodiment, as illustrated in FIG. 4, the cable (e.g., C1) may include a positive cable (e.g., C1P) and a negative cable (e.g., C1N), which are provided separately from each other in a mutually diverging manner.

According to another embodiment, as illustrated in FIG. 4, the cable (e.g., C2) may include a positive cable (e.g., C2P) and a negative cable (e.g., C2N), which are integrated with each other without mutually diverging.

Therefore, wires 154 of the positive cable C1P and the negative cable C1N of the first cable C1, which mutually diverge as individual cables, may be respectively enveloped with separate sheaths 152, and wires 154 of the positive cable C2P and the negative cable C2N of the second cable C2, which are integrated with each other without mutually diverging, may be enveloped with a single sheath 152.

Meanwhile, the cable C may include a first cable portion and a second cable portion. The first cable portion is a portion overlapping the power distribution unit 120 in the vehicle width direction (i.e., the y-axis direction), and the second cable portion is a portion extending from the first cable portion and overlapping the first module M1 in the vehicle width direction. For example, referring to FIG. 3, the first cable C1N may include a first cable portion C1N1 overlapping the power distribution unit 120 in the vehicle width direction and a second cable portion C1N2 extending from the first cable portion C1N1 and overlapping the first module M1 in the vehicle width direction.

In addition, the fuel cell module according to an embodiment may further include a fixing part. The fixing part may fix the second cable portion to the first module M1. The fixing part may be formed in a bracket shape.

For example, as illustrated in FIG. 4, the fixing part may include a first fixing part 144-1, which fixes the second cable portion of the first cable C1 to the fuel cell 110, which is the first module M1, and a second fixing part 144-2, which fixes the second cable portion of the second cable C2 to the fuel cell 110, which is the first module M1. Although the first and second fixing parts 144-1 and 144-2 are illustrated in FIG. 4 as being fixed to the fuel cell 110, the embodiments are not limited thereto. That is, the fixing part may be fixed to any of the components of the first module M1 other than the fuel cell 110.

In addition, the fuel cell module according to an embodiment may further include an impact absorbing part. The impact absorbing part envelops the cable C to protect the cable from external impact. For example, referring to FIG. 4, an impact absorbing part 142 envelops the second cable C2 to protect the second cable C2 from external impact. For example, the impact absorbing part 142 may be made of any material capable of absorbing impact and may be added to the fuel cell module in a crush shield form.

Hereinafter, a fuel cell vehicle according to a comparative example and the fuel cell vehicle according to an embodiment will be described with reference to the accompanying drawings.

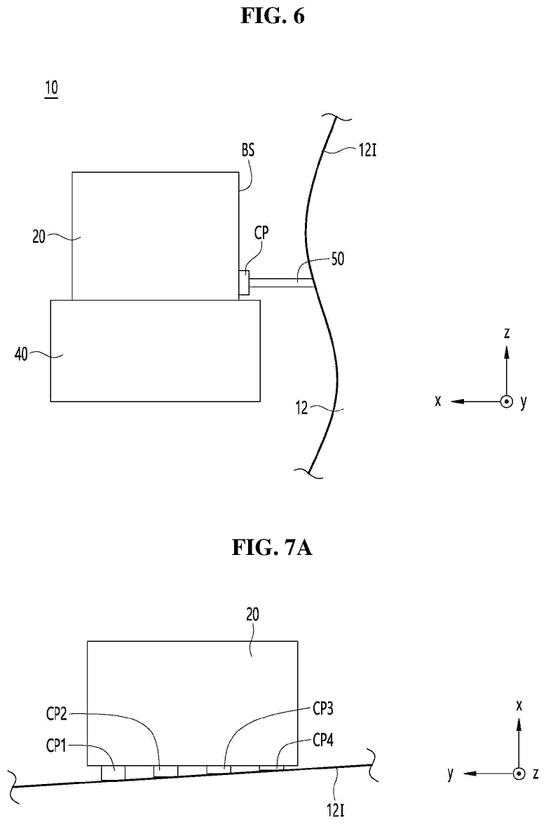

FIG. 6 is a side view of a fuel cell vehicle 10 according to a comparative example.

The fuel cell vehicle 10 according to the comparative example includes a vehicle body 12, a power distribution unit 20, a fuel cell 40, a cable 50, and a connector CP. Here, since the vehicle body 12, the power distribution unit 20, the fuel cell 40, the cable 50, and the connector CP respectively perform the same functions as the vehicle body 102, the power distribution unit 120, the fuel cell 110, the cable C, and the connector P according to the embodiment, a duplicate description thereof will be omitted.

Unlike the fuel cell vehicle 100 according to the embodiment, in the fuel cell vehicle 10 according to the comparative example, the connector CP and the cable 50 are disposed on a rear surface BS of the power distribution unit 20 in the state of being coupled to each other.

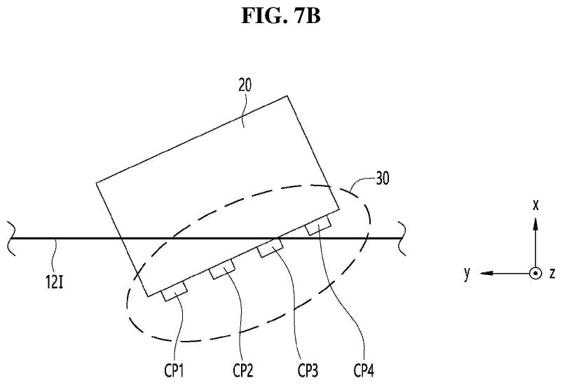

FIG. 7A is a plan view showing the state of the fuel cell vehicle according to the comparative example in the event of a head-on collision, and FIG. 7B is a plan view showing the state of the fuel cell vehicle according to the comparative example in the event of an offset collision. Illustration of the cable 50 is omitted in FIGS. 7A and 7B. In the cases illustrated in FIGS. 7A and 7B, the connector CP includes first to fourth connectors CP1, CP2, CP3, and CP4. Here, the offset collision is a collision of the vehicle with a barrier in a direction inclined by a predetermined angle from the heading direction of the vehicle.

When the fuel cell vehicle 10 according to the comparative example has a head-on collision as shown in FIG. 7A or an offset collision as shown in FIG. 7B, the connectors CP (CP1, CP2, CP3, and CP4) and the cables 50 may be sandwiched between the power distribution unit 20 and the vehicle body 12 of the vehicle 10, particularly a cowl panel (or a dash panel) 12I, as indicated by 30 in FIG. 7B, which may cause a fire in the vehicle 10. This phenomenon may further increase because the gap between the power distribution unit 20 and the cowl panel 12I is reduced due to increase in the capacity of the fuel cell 40 and increase in the volume of the power distribution unit 20.

In contrast, in the case of the fuel cell vehicle 100 according to the embodiment, the connectors P and the cables C are disposed on at least one of the first or second side surface SS1 or SS2 of the power distribution unit 120, rather than the rear surface BS of the power distribution unit 120. Therefore, in the event of the collisions shown in FIGS. 7A and 7B, the connectors P and the cables Care prevented from colliding with a cowl panel 1021 of the vehicle body 102. Therefore, in the event of vehicle collision, the cables C and the connectors P are not damaged, and the connectors P or the cables C are not sandwiched between the power distribution unit 120 and the dash panel 102I, whereby a fire does not occur.

In addition, when the cables 50 are sandwiched between the power distribution unit 20 and the dash panel 12I, a fire may spread to parts connected to the cables 50, i.e., the motor/inverter, the IDC, the CSP, the ACON, the FACM, etc. However, the embodiments may also prevent the risk of occurrence of such a fire.

In addition, when the concave portion (e.g., RE0 or RE2 shown in FIG. 2 or 5B), within which the target connector P1 among the plurality of connectors is connected to the target cable C1, is disposed as far as possible from the front side of fuel cell vehicle 100, the target connector P1 and the target cable C1 may be safely protected in the event of an offset collision as well as a head-on collision.

If the power distribution unit 120 (120A, 120B, 120C, 120D, or 120E) does not include the concave portion RE0, RE1, RE2, RE3, RE4, or RE5, and the connectors P and the cables C are disposed only on at least one of the first or second side surface SS1 or SS2 of the power distribution unit 120 (120A, 120B, 120C, 120D, or 120E), the FCMAIN connector P1, which is the target connector having a larger volume than the other connectors P2 to P4, may be connected to the target cable (e.g., C1) outside the power distribution unit, not within the concave portion RE0, RE1, RE2, RE3, RE4, or RE5. In this case, the FCMAIN connector P1 and the first cable C1 occupy a large portion of the space adjacent to the side surface of the power distribution unit 120 (120A, 120B, 120C, 120D, or 120E). Therefore, due to the curvature of the first cable C1 connected to the FCMAIN connector P1, it may be difficult to place the FCMAIN connector P1 and the first cable C1 in the space adjacent to the side surface of the power distribution unit 120 (120A, 120B, 120C, 120D, or 120E), interference may occur between the cables (e.g., C1 and C2) disposed in the space adjacent to the side surface of the power distribution unit 120 (120A, 120B, 120C, 120D, or 120E), or it may be difficult to insert the fuel cell module M into the engine compartment R in the direction indicated by the arrow A in FIG. 1A.

In contrast, according to the embodiment, since the target connector P1 having a relatively large volume is connected to the target cable C1 within the concave portion RE0, RE1, RE2, RE3, RE4, or RE5, it may be easy to place the FCMAIN connector P1 and the cable C1, no interference may occur between the cables (e.g., C1 and C2) disposed in the space adjacent to the side surface of the power distribution unit 120 (120A, 120B, 120C, 120D, or 120E), and it may be easy to insert the fuel cell module M into the engine compartment R in the direction indicated by the arrow A in FIG. 1A. Accordingly, the size of the fuel cell module M may be reduced as the extent to which the concave portion RE0, RE1, RE2, RE3, RE4, or RE5 is recessed increases.

Further, for example, as shown in FIG. 2 or 5B, when the concave portion RE0 or RE2, within which the target connector among the plurality of connectors is connected to the target cable, is disposed as far as possible from the front side of the fuel cell vehicle 100, the target connector P1 and the target cable C1 may be safely protected in the event of an offset collision as well as a head-on collision.

In addition, since the first module M1 is located closer to the outermost surfaces 102S1, 102S2, and 102F of the vehicle body 102 than the connectors P and the cables C, a much larger amount of external impact is applied to the first module M1 than to the connectors P and the cables C in the event of a collision of the fuel cell vehicle 100, whereby the connectors P and the cables C may be protected from external impact.

As a result, according to an embodiment, it is possible to secure reliability related to a collision of the fuel cell vehicle, thereby ensuring excellent quality, securing high voltage stability, and protecting vehicle users. In addition, according to an embodiment, it is possible to prevent damage to the high-voltage parts (e.g., P1 and C1) and to minimize secondary damage such as electric shock, fire, or explosion due to high leakage current caused by damage to the high-voltage parts (e.g., P1 and C1), thereby securing electrical stability at high voltage and thus meeting safety regulations for high voltage.

In addition, according to an embodiment, since the fixing parts 144-1 and 144-2 are in tight contact with the first module M1 to fix the cables C to the first module M1, the cables C may be held in place without shaking.

In addition, according to an embodiment, the impact absorbing part 142 is disposed to envelop a portion of the cable C that may be easily damaged by vibration of the fuel cell vehicle or external impact, thereby protecting the cable C from external impact. Accordingly, it is possible to secure stability of the cable and to further reduce the risk of fire attributable to damage to the cable.

Further, because the negative cable C1N and the positive cable C1P connected to the FCMAIN connector P1 have relatively large thicknesses, if these cables C1N and C1P are implemented in the same form as the second cable C2 shown in FIG. 4, rather than mutually diverging, it is not possible to flexibly bend the cable C1 or to freely change the extending direction of the cable C1. In contrast, according to an embodiment, since the negative cable (e.g., C1N) and the positive cable (e.g., C1P) of the target cable (e.g., C1) are provided separately from each other in a mutually diverging manner, it is possible to improve workability in mounting the cable and to more freely implement the configuration of the cable by virtue of a longitudinal margin corresponding to a length difference between the negative cable (e.g., C1N) and the positive cable (e.g., C1P). Accordingly, a process of inserting the fuel cell module M into the engine compartment R of the fuel cell vehicle 100 (refer to FIG. 1B) may be easily performed, whereby manufacture of the fuel cell vehicle 100 may be facilitated. Further, when the fuel cell module M is inserted into the engine compartment R (refer to FIG. 1B), a gap (i.e., a decking gap) between the engine compartment R and the fuel cell module M may be secured, whereby there is no risk of the cable (particularly, the target cable) being damaged or scratched, and the risk of nearby components being damaged by shaking of the cable (particularly, the target cable) due to vibration of the fuel cell vehicle 100 may be reduced.

In addition, according to an embodiment, since the fixing part 144-1 is disposed to envelop each of the diverging negative and positive cables, the cables may be more firmly fixed.

In addition, in the fuel cell vehicle 100 according to an embodiment, the fuel cell 110 and the connectors P may be modularized, or the fuel cell 110, the connectors P, and the cables C may be modularized. Therefore, the fuel cell, the connectors, and the cables may be sold in fuel cell module units.

As is apparent from the above description, according to a fuel cell module and a fuel cell apparatus including the same of embodiments, it is possible to secure reliability related to a collision of a fuel cell vehicle, which is the fuel cell apparatus, thereby ensuring excellent quality, securing high voltage stability, and protecting vehicle users. In addition, it is possible to prevent fire or damage to high-voltage parts and to minimize secondary damage due to damage thereto, thereby securing electrical stability at high voltage and thus meeting safety regulations for high voltage. In addition, it is possible to avoid interference between adjacent cables and to facilitate insertion of the fuel cell module into an engine compartment. In addition, the size of the fuel cell module may be reduced as the extent to which a concave portion is recessed increases. In addition, cables may be more firmly fixed, and a fuel cell and connectors may be sold in module units.

However, the effects achievable through embodiments of the disclosure are not limited to the above-mentioned effects, and other effects not mentioned herein will be clearly understood by those skilled in the art from the above description.

The above-described various embodiments may be combined with each other without departing from the scope of the present disclosure unless they are incompatible with each other.

In addition, for any element or process that is not described in detail in any of the various embodiments, reference may be made to the description of an element or a process having the same reference numeral in another embodiment, unless otherwise specified.

While embodiments of the present disclosure have been particularly shown and described with reference to exemplary embodiments thereof, these embodiments are only proposed for illustrative purposes and do not restrict the embodiments of the present disclosure, and it will be apparent to those skilled in the art that various changes in form and detail may be made without departing from the essential characteristics of the embodiments set forth herein. For example, respective configurations set forth in the embodiments may be modified and applied. Further, differences in such modifications and applications should be construed as falling within the scope of the present disclosure as defined by the appended claims.

What is claimed is:

1. A fuel cell module comprising:
a fuel cell;
a power distribution unit disposed above the fuel cell, the power distribution unit comprising a concave portion; and
a cable configured to be connected to a connector of the power distribution unit within the concave portion.

2. The fuel cell module according to claim 1, wherein:
the power distribution unit comprises:
a front surface;
a rear surface located opposite the front surface in a first direction; and
first and second side surfaces facing each other in a vehicle width direction between the front surface and the rear surface, the vehicle width direction being a direction intersecting the first direction; and
the connector is disposed on the first side surface or the second side surface to be connected to the cable.

3. The fuel cell module according to claim 2, wherein the concave portion is disposed closer to the rear surface of the power distribution unit than to the front surface of the power distribution unit.

4. The fuel cell module according to claim 2, wherein:
the concave portion is spaced apart from the front surface of the power distribution unit and is contiguous with the rear surface of the power distribution unit; and
the connector and the cable are connected to each other within the concave portion while being spaced apart from a virtual rear surface, the virtual rear surface being a virtual surface extending from the rear surface in the vehicle width direction.

5. The fuel cell module according to claim 2, wherein the concave portion is located at a corner between the first side surface or the second side surface of the power distribution unit and the rear surface of the power distribution unit.

6. The fuel cell module according to claim 5, wherein the concave portion has a cut-out, chamfered, or filleted planar shape.

7. A fuel cell apparatus comprising the fuel cell module according to claim 1.

8. A fuel cell module comprising:
a fuel cell;
a power distribution unit disposed above the fuel cell, the power distribution unit comprising:
a concave portion;
a front surface;
a rear surface located opposite the front surface in a first direction; and
first and second side surfaces facing each other in a vehicle width direction between the front surface and the rear surface, the vehicle width direction being a direction intersecting the first direction;
a cable configured to be connected to a connector of the power distribution unit within the concave portion, wherein the connector is disposed on the first side surface or the second side surface to be connected to the cable;
a fuel cell driving unit configured to assist driving of the fuel cell; and
a vehicle driving unit configured to assist driving of a vehicle equipped with the fuel cell module;
wherein a first module of the fuel cell module comprises the fuel cell, the fuel cell driving unit, and the vehicle driving unit; and
wherein a second module of the fuel cell module comprises the power distribution unit and the connector.

9. The fuel cell module according to claim 8, wherein the second module completely overlaps the first module in a vertical direction.

10. The fuel cell module according to claim 8, wherein an outermost side of the first module is located farther away from the first side surface or the second side surface of the power distribution unit in the vehicle width direction than an outermost side of the connector.

11. The fuel cell module according to claim 8, wherein a separation distance between an outermost side of the first module and the first side surface or the second side surface of the power distribution unit in the vehicle width direction is longer than or equal to a separation distance between an outermost side of the connector and the first side surface or the second side surface of the power distribution unit in the vehicle width direction.

12. The fuel cell module according to claim 8, wherein a separation distance between an outermost side of the first module and an outermost side of the cable in the first direction is longer than or equal to a separation distance between the outermost side of the cable and the front surface of the power distribution unit in the first direction.

13. The fuel cell module according to claim 8, wherein the cable comprises:
a first cable portion overlapping the power distribution unit in the vehicle width direction; and
a second cable portion extending from the first cable portion and overlapping the first module in the vehicle width direction.

14. The fuel cell module according to claim 13, further comprising a fixing part configured to fix the second cable portion to the first module.

15. A fuel cell module comprising:
a fuel cell;
a power distribution unit disposed above the fuel cell, the power distribution unit comprising a concave portion;
a plurality of connectors configured to respectively output multiple different levels of voltages; and
a plurality of cables configured to be respectively connected to the plurality of connectors within the concave portion.

16. The fuel cell module according to claim 15, wherein:
a highest level of voltage is output through a target connector among the plurality of connectors;
the plurality of cables comprises a target cable configured to be connected to the target connector; and
the target connector and the target cable are connected to each other within the concave portion.

17. The fuel cell module according to claim 16, wherein the target connector comprises an FCMAIN connector configured to output a voltage required by a load of a vehicle equipped with the fuel cell module.

18. The fuel cell module according to claim 15, wherein each of the plurality of cables comprises:
a positive cable connected to a positive voltage output through a corresponding connector of the plurality of connectors; and
a negative cable connected to a negative voltage output through a corresponding connector of the plurality of connectors.

19. The fuel cell module according to claim 18, wherein the positive cable and the negative cable of one cable of the plurality of cables are provided separately from each other in a mutually diverging manner.

20. The fuel cell module according to claim 18, wherein the positive cable and the negative cable have different lengths.
